(19) United States
(12) Patent Application Publication
(10) Pub. No.: US 2021/0337608 A1
(43) Pub. Date: Oct. 28, 2021

(54) SENSOR DATA QUALITY AS A TRIGGER TO CHECK ON-BODY PRESENCE AND FACILITATE UN-PAIRING

(71) Applicant: KONINKLIJKE PHILIPS N.V., EINDHOVEN (NL)

(72) Inventors: VINCENTIUS PAULUS BUIL, VELDHOVEN (NL); LUCAS JACOBUS FRANCISCUS GEURTS, BEST (NL)

(21) Appl. No.: 16/479,635

(22) PCT Filed: Jan. 29, 2018
(86) PCT No.: PCT/EP2018/052070

§ 371 Date: Jul. 22, 2019

(30) Foreign Application Priority Data
Jan. 30, 2017 (EP) 17153763.2

(51) Int. Cl. H04W 76/14; H04W 84/18; H04W 4/029

(52) U.S. Cl. CPC H04W 76/14; H04W 4/029; H04W 84/18

(57) ABSTRACT

A method and apparatus for providing a communication method comprising: receiving at a first communication device, a signal from a second communication device over a first communication channel, said signal comprising first information; transmitting a response from said first communication device to said second communication device, said response being dependent on said signal received from said second communication device, wherein one of said first and second communication channels is a body coupled communication channel and the other of said first and second communication channels is a radio frequency channel.

### TECHNICAL FIELD OF THE INVENTION

Body-coupled communication (BCC) can detect whether two devices are connected via a human or animal body. In order to achieve this both devices must be in contact with, or in close proximity (˜few cm) of the same human or animal body. Some embodiments may provide extra context to sensor readings in a body sensor network (BSN) and which may initiate pairing and/or un-pairing actions.

### BACKGROUND OF THE INVENTION

Body-coupled communications (BCC) or body-based communication has been proposed as a basis for body area networks (BANs) as standardized by the 802.15.6 Task Group of the Institute of Electrical and Electronics Engineers (IEEE). BCC allows exchange of information between a plurality of devices which are at or in close proximity of a body of a human or an animal. This may be achieved by capacitive or galvanic coupling of low-energy electric fields onto the body surface.

Body-coupled communication (BCC) uses a human or animal body as communication channel. It enables wireless communication over a human or animal body between devices that are in contact with that human or animal body. Signals are conveyed over the body instead of through the air. As such, the communication is confined to an area on or close to the body. Therefore, communication is possible between devices situated on, connected to, or placed close to the body.

Work has been carried out on body area networks (BANs), and more specifically in the area of body sensor networks (BSNs). BSNs enable health monitoring and coaching applications via sensor patches worn on the body that communicate via a body area network such as for example Bluetooth; industrial, scientific and medical (ISM) bands; or body-coupled communication with a bridge or hub.

The bridge may be a smart phone, or any wearable or other smart device such as a smart watch, pendant, augmented reality glasses, implantable device, or textile embedded electronics, that may connect the BAN with larger networks such as WiFi or cellular which may connect to the cloud. FIG. 1 shows a body area network (BAN) consisting of several sensors/actuators 101 to 111 on the body, along with a (wireless) bridge unit 113 (often a users' smartphone) as well as internet 119) connectivity through access points 115 and 117.

Companies are currently investigating the use of sensor patches and BSNs in medical domains, for example for patient monitoring in both hospitals and at home. In hospitals the BSNs are typically applied and configured by hospital staff, for example nurses. In hospitals, it is desirable that sensors are connected to the correct bridge, in order to avoid medical errors. At home, patients themselves may manage their sensor patches and, for example, replace patches that have run out of power. Such patients may have arthritis, reduced cognitive abilities and/or reduced eye-sight, as such the activity of managing sensor patches should be easy.

Current technologies involving wireless patch sensors for medical applications envisage using RF communications, for example Bluetooth LE (low energy), to communicate with a bridge or hub. These devices may connect to remote devices to allow patient monitoring/coaching at a distance. However, such technologies may suffer from the problems of: suboptimal patch positioning (location or contact with skin); connections to the wrong bridge; interference; and/or detachment or power-loss.

Some embodiments may seek to address one or more of these issues.

### SUMMARY OF THE INVENTION

According to one aspect, there is provided a communication method comprising: receiving at a first communication device, a signal from a second communication device over a first communication channel, said signal comprising first information; transmitting a response from said first communication device to said second communication device over a second communication channel, said response being dependent on said signal received from said second communication device and initiating by said second communication device, pairing if said response matches a criterion, on said second communication channel, between said first and second devices, wherein one of said first and second communication channels is a body coupled communication channel and the other of said first and second communication channels is a radio frequency channel.

This may be advantageous as communication via the body-coupled communication channel ensures that the first and the second device are connected to the same body.

According to another aspect, there is provided a communication method comprising: transmitting at a second communication device, a signal over a first communication channel to a first communication device, said signal comprising first information; receiving a response from said first communication device over a second communication channel, said response being dependent on said signal transmitted from said second communication device and initiating by said second communication device, pairing if said response matches a criterion, on said second communication channel, between said first and second devices, wherein one of said first and second communication channels is a body coupled communication channel and the other of said first and second communication channels is a radio frequency channel.

This may be advantageous as communication via the body-coupled communication channel ensures that the first and the second device are connected to the same body.

In some embodiments, a two-tier pairing scheme may be provided. The first tier may utilize a low bandwidth communication channel, which may be for example body-coupled communication (BCC) to initiate pairing with a wireless bridge, and the second tier may utilize a high bandwidth communication channel, which may be for example Bluetooth low energy (BLE) or other wireless pairing for subsequent data transfer.

For example, if a patient or other user has intentionally removed a sensor patch from the patient's body, the bridge device may recognize this and not indicate that it is receiving invalid sensor readings. In some embodiments, an intentional removal of a sensor patch may cause the sensor to disassociate (un-pair) from the BSN. The low bandwidth communication channel (BCC) may provide information to assist in recognizing the intentional removal.

In some embodiments one sensor device may be used, in other embodiments any number of sensor devices may be used.

In some embodiments one bridge (hub) device may be used, in other embodiments any number of bridge devices may be used.

In some embodiments the bridge communicates with a remote device, for example a sensor device.

In some embodiments a remote device communicates with a bridge device, for example a smart device.

In some embodiments the bridge device and the remote device may have paired and/or unpaired communications.

One of the first and second communication devices may be a bridge device, and the other of the first and second communication devices may be a sensor device.

The method may comprise that a quality of information received by one of said first and said second communication devices from the other of said first and said second communication devices is used to determine a relative location of the one device relative to the other.

This may be advantageous as location information may be used to provide information as to whether the first and second device are attached to the correct part of the body.

The method may comprise determining from said determined relative location if one of said first and second devices is to be moved from a current location and if so providing output information indicating that said one of said devices is to be moved.

This may be advantageous as providing the information indicating that one of said first and second devices is to be moved from a current location may allow a user to re-position the one of said first and second devices.

The method may comprise that the quality of information received by one of said first and said second communication devices from the other of said first and said second communication devices is used to determine if said first and second communication devices are no longer communicating via one of said channels.

This may be advantageous as this may allow the first and/or second device to stop transmitting and/or receiving and/or enter a low power mode.

The method may further comprise that one of said channels is a body coupled communication channel.

This may be advantageous as this may allow the first and said second communication devices to be certain that they are no longer attached to the same body.

The method may comprise that one of said first and second communication channel is a relatively high bandwidth communication channel and the other of the first and second communication channel is a relatively low bandwidth communication channel.

This may be advantageous as by using at least one low bandwidth communication channel, the first and second communication devices may consume less power.

The method may comprise that one of said first and second communication devices is a sensor device and the other of said first and second communication devices is a bridge device.

The method may further comprise pairing said first and said second communication devices. This may be advantageous as it may allow the first and second communication devices to expect the transmission and receiving of information between the first and second communication devices.

The method may further comprise un-pairing of said first and said second communication devices. This may be advantageous as it may allow the first and second communication devices to stop expecting the transmission and receiving of information between the first and second communication devices.

The method may comprise that when information is not received by one of said first and said second communication devices from the other of said first and said second communication devices said first and second communication devices un-pair after a specified duration. This may be advantageous as it may allow the first and second communication devices to stop expecting the transmission and reception of information between the first and second communication devices. This may save power.

The method may comprise that when information is not received by one of said first and said second communication devices via at least one body coupled communication channel from the other of said first and said second communication devices, said first and second communication devices un-pair after a specified duration. This may be advantageous as if signal is not provided via at least one body coupled communication channel between said first and said second communication devices, it may be that one of said first and said second communication devices are no longer attached to the same body, and as such said first and said second communication devices may no longer expect the transmission and reception of information between the first and second communication devices.

The method may comprise one of said first and second communication devices receiving monitor information and the other of said first and second communication devices transmitting monitor information. This may be advantageous as it may allow, for example, the health of a patient to be monitored.

The method may comprise that a quality of the monitor information received by one of said first and said second communication devices from the other of said first and said second communication devices is used to determine a relative location of the one device relative to the other. This may be advantageous as location information may be used to provide information as to whether the first and/or second device are attached to the correct part of the body.

The method may comprise that the signal strength of the one or more body coupled communication channel received by one of said first and said second communication devices from the other of said first and said second communication devices is used to determine a relative location of the one device relative to the other. This may be advantageous as location information may be used to provide information as to whether the first and/or second device are attached to the correct part of the body.

The method may further comprise determining from said determined relative location if one of said first and second devices is to be moved from a current location and if so providing output information indicating that said one of said devices is to be moved. This may be advantageous as providing the information indicating that one of said first and second devices is to be moved from a current location may allow a user to re-position the one of said first and second devices.

The method may comprise that the signal strength of the one or more body coupled communication channel received by one of said first and said second communication devices from the other of said first and said second communication devices is used to determine if said first and second communication devices are no longer communicating via one of said channels. This may be advantageous as this may allow the first and/or second device to stop transmitting and/or receiving and/or enter a low power mode.

The method may comprise determining if a subsequent signal is one of received or transmitted within a respective time, and if not causing at least one of said first communication device and said second communication device to be in a lower power mode. This may be advantageous as it may allow at least one of said first communication device and said second communication device to save power.

The method may comprise that when a signal quality of the body coupled communication channel received by one of said first and said second communication devices from the other of said first and said second communication devices is used to determine said relative location of the one device relative to the other. This may be advantageous as location information may be used to provide information as to whether the first and/or second device are attached to the correct part of the body.

The method may further comprise determining from said determined relative location if one of said first and second devices is to be moved from a current location and if so providing output information indicating that said one of said devices is to be moved. This may be advantageous as providing the information indicating that one of said first and second devices is to be moved from a current location may allow a user to re-position the one of said first and second devices.

The method may comprise that the signal quality received by one of said first and said second communication devices from the other of said first and said second communication devices is used to determine if said first and second communication devices are no longer communicating via one of said channels. This may be advantageous as this may allow the first and/or second device to stop transmitting and/or receiving and/or enter a low power mode.

In another aspect, there is provided first communication device comprising a receiver configured to receive a signal from a second communication device over a first communication channel, said signal comprising first information; and a transmitter configured to transmit a response to said second communication device over a second communication channel, said response being dependent on said signal received from said second communication device and being configured to cause said second communication device to initiate a pairing between said first and second communication devices on said second communication channel by matching a criterion, wherein said first communication channel is a body coupled communication channel and said second communication channel is a radio frequency channel.

In another aspect, there is provided a second communication device comprising a transmitter configured to transmit a signal over a first communication channel to a first communication device, said signal comprising first information; and a receiver configured to receive a response from said first communication device over a second communication channel, said response being dependent on said signal transmitted from said second communication device, the second device being configured to initiate pairing if said response matches a criterion, on said second communication channel, between said first and second devices, wherein said first communication channel is a body coupled communication channel and said second communication channel is a radio frequency channel.

### BRIEF DESCRIPTION OF THE DRAWINGS

Some embodiments will now be described by way of example only and with reference to the accompanying Figures in which:

FIG. 1 schematically shows an embodiment of a body-coupled communication BCC system;

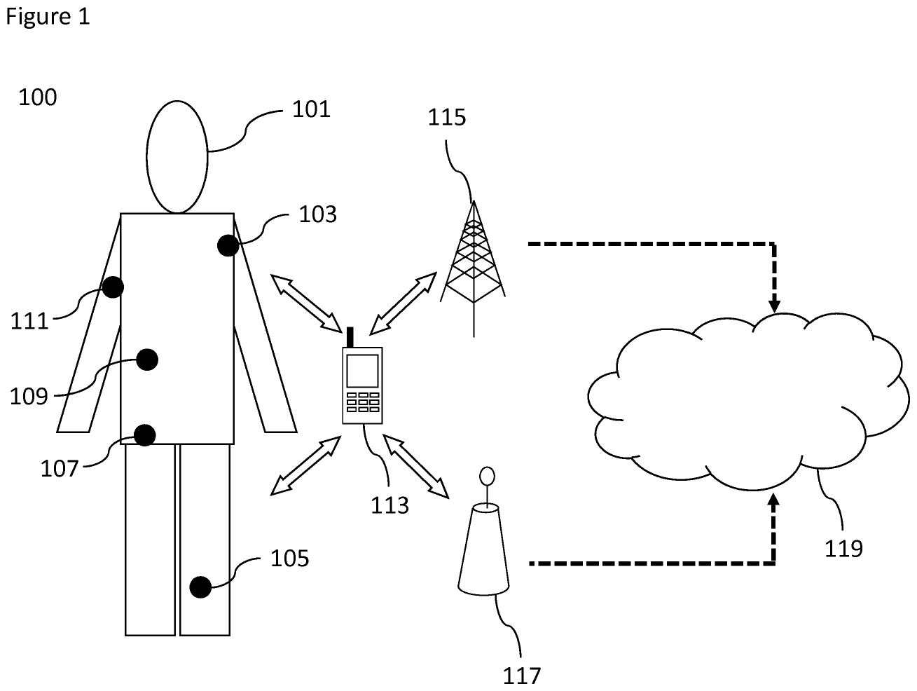

FIG. 2 schematically shows a bridge device;

FIG. 3 schematically shows a sensor device;

FIG. 4 schematically shows a method for pairing the bridge device and the sensor device;

FIG. 5 schematically shows a method for un-pairing the bridge device and sensor device;

FIGS. 6a and 6b schematically show an example of how a low bandwidth channel (BCC) and high bandwidth channel (BLE) cooperate; and

FIG. 7 which shows an example of a method of determining whether a sensor patch requires re-positioning.

### DETAILED DESCRIPTION OF EMBODIMENTS

Body-coupled communication (BCC) may be utilized to detect whether two devices are connected to the same human body. It should be appreciated that bodies of animals may also be used, for example the bodies of pets, or farm animals. In order to achieve this both devices need to touch, or be in close proximity (˜a few cm) of the same human or animal body. Some embodiments utilize this property to provide extra context to sensor readings in the BSN and to initiate pairing and un-pairing actions.

In some systems a body sensor network (BSN) is provided which comprises of a low bandwidth communication channel (e.g. <250 Kbps) and a high bandwidth communication channel (e.g. >1 Mbps) that may be used for different purposes. For example, the low bandwidth channel may be used for simple control and identification signals to detect if one or more sensors (or other remote devices) and one or more bridges (or hubs) are attached to the same body, whereas the high bandwidth channel may be used for data streaming to enable sensor data communication. It should be appreciated that the high bandwidth communication channel is a relatively high bandwidth compared to the low bandwidth communication channel.

The low bandwidth channel and the high bandwidth channel may reside in one networking technology, such as body-coupled communication (BCC). Alternatively these channels may use different networks, wherein the low bandwidth channel is executed through body-coupled communication and the high bandwidth channel is executed through RF communication, for example, Bluetooth Low-Energy (BLE) or M-BAN.

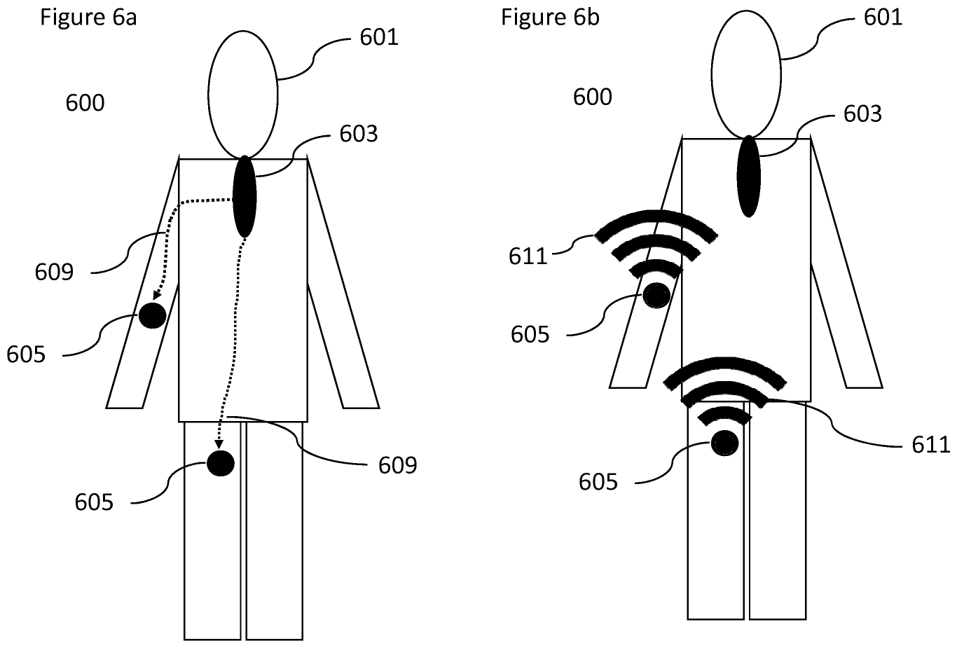

FIGS. 6a and 6b show an example of how the low bandwidth channel (BCC) and high bandwidth channel (BLE) may cooperate.

A possible embodiment of a body sensor network will now be described with reference to FIGS. 6a and 6b. In FIG. 6a, a patient 601, has a bridge or hub device 603 which is attached to their body. The bridge or hub device 603 is able to communicate with the sensors or other remote device 605 using one or more low bandwidth communication channels 609 which may be for example body-coupled communication (BCC) channels.

In FIG. 6a, the bridge device 603 transmits a bridge identification (ID) signal via the one or more low bandwidth communication channels 609.

In FIG. 6b, the sensors 605 have received the bridge identification (ID) signal from the bridge device 603 via the one or more low bandwidth communication channels 609. The sensors 605 then transmit the bridge identification (ID) signal via one or more high bandwidth communication channels 611, which may be for example Bluetooth low energy (BLE). Once the bridge device 603 has received bridge identification (ID) signal from the sensors 605 via the one or more high bandwidth communication channels 611, the bridge device 603 may pair with the sensors 605.

In some embodiments the bridge device 603 transmits the identification (bridge ID) on the one or more high bandwidth communication channels, and waits to receive the same identification (bridge ID) or associated information related to the identification via the one or more low bandwidth communication channels.

Alternatively or additionally, the sensor device(s) 605 may transmit an identification (sensor ID) to the bridge device 603 via the one or more low bandwidth communication channels, and wait to receive the same identification (sensor ID) or associated information related to the identification via the one or more high bandwidth communication channels.

Alternatively or additionally, the sensor device(s) 605 may transmit an identification (sensor ID) to the bridge device 603 using the one or more high bandwidth communication channels, and wait to receive the same identification (sensor ID) or associated information related to the identification via the one or more low bandwidth communication channels.

In some embodiments at least one of the low bandwidth communication channels is a body-coupled communication channel.

In some embodiments at least one of the high bandwidth communication channels is a body-coupled communication channel.

Some embodiments rely on one of the channels being a body coupled communication channel to ensure that the sensor device(s) is communicating with a bridge device on the same patient.

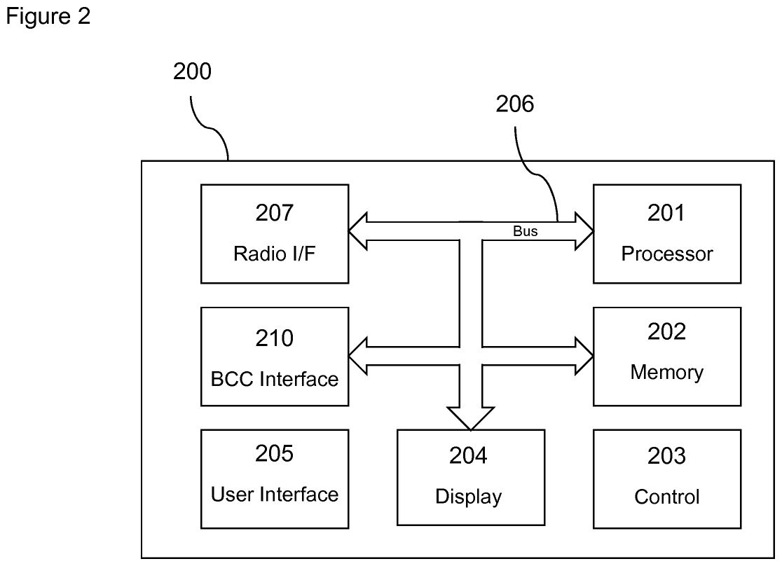

An example embodiment of a bridge device will now be described with reference to FIG. 2 which shows an exemplary schematic diagram of a bridge device 200. Such a bridge device may be referred to as a hub device. An appropriate bridge device may be provided by any device capable of sending and receiving body coupled communication signals as well as radio signals.

The bridge device 200 may transmit and receive signals over a high bandwidth communication link using an air or radio interface 207 in order to communicate with other devices, for example one or more sensor devices. The bridge device 200 may also transmit and receive signals over a low bandwidth communication link via a body-coupled communication (BCC) interface 210 in order to communicate with other devices, for example one or more sensor devices. These interfaces are provided by one or more transceivers. The bridge device may be provided with at least one data processing entity 201, at least one memory 202, and other relevant control apparatus 203. The data processing, storage and other relevant control apparatus may be provided on an appropriate circuit board and/or in chipsets. The bridge device may have a suitable user interface 205 to allow a user to control the bridge device. In some embodiments, the user interface may be omitted and one or other or both of the BCC and radio interfaces may communicate with a device to which the user provides input to control the bridge device. The bridge device may have a suitable display 204 which may provide the user with the status of the bridge device, and any devices that are in communication with the bridge device, i.e. within the body area network, for example the status of any sensor devices that are connected to the bridge device. Alternatively the bridge device may provide an output which may be displayed on a separate display device.

The components of the bridge device may communicate via a bus 206. The bridge device 200 may further comprise any appropriate connectors (either wired or wireless) to allow connection and/or communication with other devices and/or for connecting external accessories.

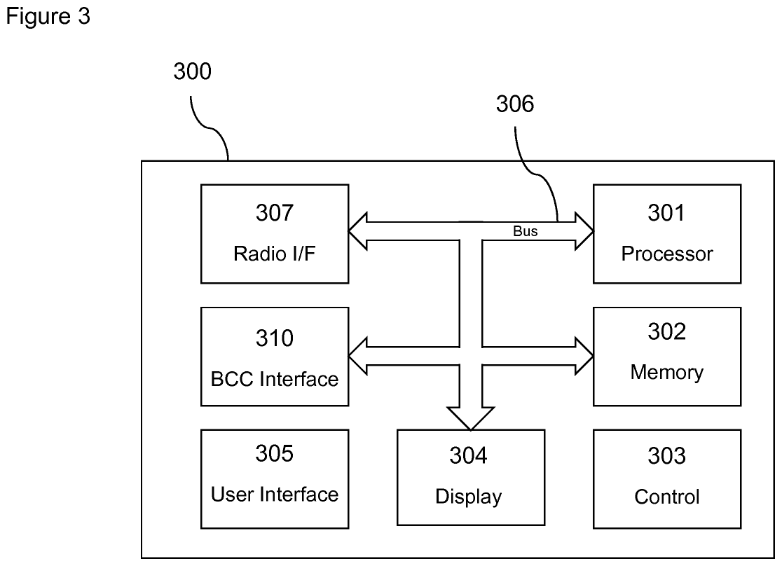

An example embodiment of a sensor device will now be described with reference to FIG. 3, which shows an exemplary schematic diagram of a sensor device 300. An appropriate sensor device may be provided by any device capable of sending and receiving body-coupled communication signals as well as radio signals.

The sensor device 300 transmits and receive signals over a high bandwidth communication link via an air or radio interface 307 in order to communicate with other devices, for example the bridge device. The sensor device 300 may also transmit and receive signals over a low bandwidth communication link via body-coupled communication interface 310 in order to communicate with other devices, for example the bridge device. The sensor device may be provided with at least one data processing entity 301, at least one memory 302, and other relevant control apparatus 303. The data processing, storage and other relevant control apparatus may be provided on an appropriate circuit board and/or in chipsets.

The sensor device may have a suitable user interface 305 to control the sensor device. In some embodiments, the user interface may be omitted and one or other or both of the BCC and radio interfaces may communicate with a device to which the user provides input to control the sensor device. In some embodiments, the sensor device may be controlled by the bridge device.

The sensor device may have a suitable display 304 which may provide the user with the status of the sensor device, and any devices that are in communication with the sensor device, i.e. within the body area network, for example the status of any bridge devices that are connected to the sensor device. Alternatively the sensor device may provide an output which may be displayed on a separate display device or may be passed to and displayed by the bridge device.

The components of the sensor device may communicate via a bus 306. The sensor device 300 may further comprise any appropriate connectors (either wired or wireless) to allow connection and/or communication with other devices and/or for connecting external accessories.

In some embodiments a person carrying a bridge device, for example a patient, receives a new sensor. The new sensor broadcasts its unique ID via a high bandwidth channel, for example Bluetooth low energy (BLE), but the sensor may not pair with the bridge. The bridge device (hub) transmits its unique ID via a low bandwidth channel, for example BCCs, and may only pair with the sensor when the sensor has detected the ID of the bridge device and sent it back to the bridge via the high bandwidth communication channel (BLE).

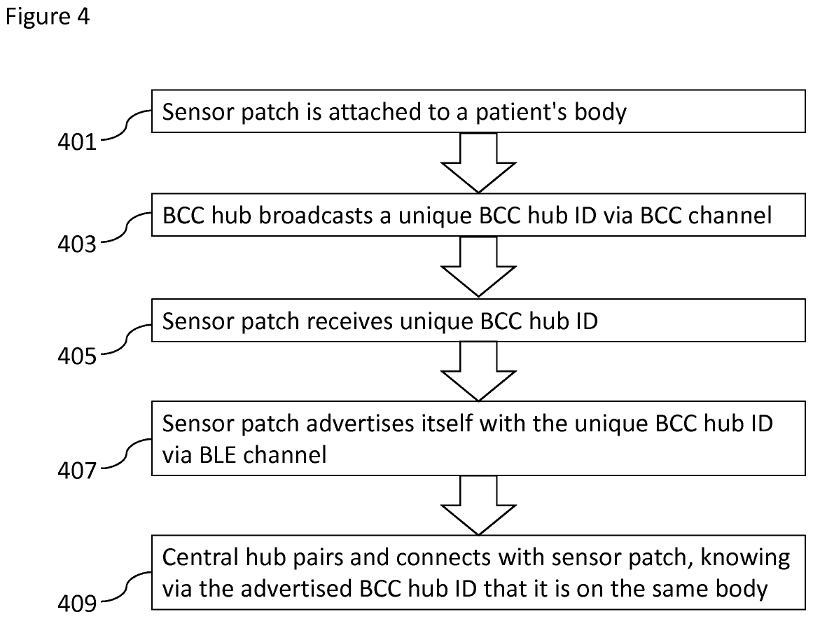

Reference is now made to FIG. 4 which shows an example of a method for pairing the bridge device and the sensor device.

In step 401, a sensor device is attached to a patient's body. This sensor device may be in the form of a patch. The person adding the new sensor unit, for example a medical professional, may activate the sensor unit to be added, alternatively or additionally the sensor unit may be activated upon contact with the skin of a patient. Activation may cause the high bandwidth channel of the sensor to be switched on and/or for the sensor to advertise itself on the high bandwidth communication channel (BLE). Alternatively or additionally the activation may cause the BCC mode to be switched on and/or for the sensor to advertise itself on the low bandwidth communication channel.

In step 403, the bridge (BCC hub) may detect, for example via the high bandwidth communication channel, the new sensor and may activate a low bandwidth communication channel, for example BCC channel, to broadcast its own unique ID (BCC hub ID) via the low bandwidth communication channel. In some embodiments, the bridge unit using the high bandwidth communication channel, for example BLE, may always be in discovery mode.

In step 405, the sensor receives the unique BCC hub ID from the patient's bridge. The sensor patch may only be able to receive the unique BCC hub ID signal from the bridge via a body-coupled communication channel, ensuring that the sensor patch is attached to the same body as the bridge.

In step 407, the sensor patch may advertise itself with the unique BCC hub ID via, for example the high bandwidth communication channel (BLE), such that the bridge detects whether a new patch is physically attached to the same patient's body or not.

In step 409, the bridge may listen for its own ID in the high bandwidth communication channel advertisement list, and if it detects its own ID, the bridge pairs and connects with the sensor patch, knowing via the advertised BCC hub ID that the patch is on the same body as the bridge device. The bridge may now pair with the sensor and may add it to the body sensor network (BSN).

If the bridge does not detect its own unique BCC hub ID in the high bandwidth communication channel (BLE) advertisement list, it may not yet pair with new sensor. A time out mechanism may be used. For example, the bridge may utilize a timing mechanism which may commence on the performing of an action at the bridge, for example, transmitting the BCC hub ID via one of the BCC channels, or receiving the BCC hub ID via one of the high bandwidth channels. Alternatively or additionally a counter mechanism may be used, which counts the number of successfully transmitted and/or received hub IDs. For example, there may be a pre-defined number of transmitted and/or received hub IDs and if this pre-defined number is not met, the bridge does not pair with the new sensor. The pre-defined number of transmissions may be user defined, or defined by the manufacturer.

In some embodiments the sensor patch may receive the unique BCC hub ID via a high bandwidth communication channel, e.g. BLE, and advertise itself to the bridge with the unique BCC hub ID via a body-coupled communication channel, again ensuring that the sensor patch is attached to the same body as the bridge.

In an alternative embodiment the sensor may emit its unique ID (sensor ID) via low bandwidth communication channel (BCC). The sensor may also advertise itself on the high bandwidth communication channel (BLE) annotated with the sensor ID that is transmitted via the low bandwidth communication channel (BCC).

Some embodiments provide that the bridge only pairs with the sensor, when the bridge detects the sensor in the high bandwidth communication channel (BLE) list whilst simultaneously detecting the sensor ID in the list via the low bandwidth communication channel (BCC).

In some embodiments a physiological signal measured by a sensor may be compared to a physiological signal at the bridge. If it is determined that these physiological signals are the same, it may be determined that the sensor and the hub are attached to the same patient. The physiological signal may, for example, be a skin response signal, or a heart rate signal, which may be correlated at two different points on the body of the patient to determine that the sensor is may be, or may still be attached to the body of the same patient.

Further sensors may be added to the patient's body, and may be connected to the same, and/or another bridge utilizing the same or a similar method, wherein a unique ID may transmitted to a corresponding device via a body coupled communication channel.

Some embodiments have an advantage in that, as the sensor may only receive the unique ID from the bridge, when in direct or near contact with the body of the patient, the bridge can be sure that the sensor is on the correct patient and not someone nearby.

In some embodiments worn sensor units may be provided which may communicate via the body area network (BAN) to the bridge. The sensor units may include metadata on sensor data validity in their communication. When a communication is set up with a sensor device, the sensor may provide sensor data to the bridge or hub.

The bridge receives data from one or more sensor units via a BAN and which may connect to other networks. As discussed previously, the BAN comprises a low bandwidth communication channel for on/near the same body detection of sensor unit(s) and the bridge, for example via body-coupled communication, and a high bandwidth communication channel for data communication between sensor unit(s) and the bridge, for example via BLE, ANT, M-BAN and/or other RF network.

In some embodiments, the signal quality of the body-coupled communication channel and/or the quality of the transmitted information may be indicative of correct sensor placement. For example, if the sensor readings are suboptimal or invalid and/or the signal quality of the body-coupled communication is suboptimal (but not necessarily lacking), this is an indication that the sensor patch (or the bridge, or both) may not be attached correctly to the body. In such an example, the bridge may provide feedback guiding the user to check the attachment of the sensor to the body. If, for example, the sensor readings are suboptimal and/or invalid, but the signal quality of the body-coupled communication is optimal, then it is likely that the sensor is attached correctly to the body, but placed at the wrong position. In such an example, the bridge may provide feedback to the user to adjust the sensor positioning.

Furthermore, the signal strength of the high bandwidth communication channel (e.g. the wireless channel) and/or the low bandwidth communication channel (e.g. the BCC channel) may also provide information to the bridge and/or sensor, on the distance between the sensor and the bridge. This information, for example, may also be used for sensor placement guidance. For example, if the sensor is attached to the chest of a patient but the strength of one of, and/or both of the communication channels suggests that it is attached to the leg of a patient, an indication to re-attach the sensor in an expected location may be provided by the bridge and/or sensor. This functionality may require reference values which may, for example, be pre-defined by a user and/or previously measured by the system on the same or another patient, and/or may be contained in a reference table.

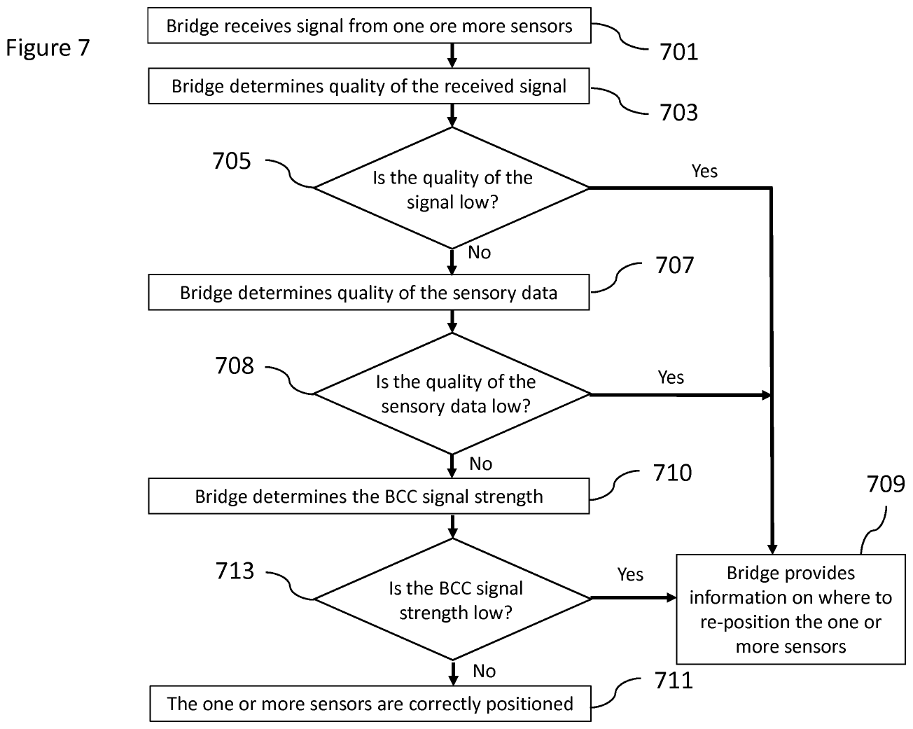

Reference is now made to FIG. 7 which shows an example of a method of determining whether a sensor patch requires re-positioning.

In step 701, a bridge device receives a signal containing sensory information from the one or more sensors, via one or more high bandwidth communication channels and/or via one or more low bandwidth communication channels.

In step 703, the bridge device may then determine the quality of the received signal.

In step 705, the bridge compares the quality of the received signal against a pre-defined threshold value. If the quality of the signal is deemed to be lower than the pre-defined threshold value, the bridge device may provide information on where to position and/or re-position the one or more sensors 709.

If the signal quality is found to be higher than the pre-defined threshold value in step 705, the bridge device may determine the quality of the sensory data contained within the received signal 707.

In step 708, the bridge compares the quality of the sensory data against a pre-defined threshold value. If the quality of the sensory data is deemed to be lower than the pre-defined threshold value, the bridge device may provide information on where to position and/or re-position the one or more sensors 709.

If the quality of the sensory data is found to be higher than the pre-defined threshold value in step 708, the bridge device may determine the signal strength of the one or more body-coupled communication channels 710.

In step 713, the bridge compares the signal strength of the one or more body-coupled communication channels against a pre-defined threshold value. If the signal strength of the one or more body-coupled communication channels is deemed to be lower than the pre-defined threshold value, the bridge device may provide information on where to position and/or re-position the one or more sensors 709.

It should be appreciated that the sets of steps 703 to 705, steps 707 to 708, and steps 710 to 713 may be performed regardless of the outcome of any of the other sets of steps, and that first performing the measuring and determination of the sets of steps 703 to 705, steps 707 to 708, or steps 710 to 713 does not preclude the measurement and determination of any of the other sets. Furthermore the sets of steps 707 to 708, steps 703 to 705, and steps 710 to 713 may be performed in any order, and/or concurrently.

In some embodiments the method of determining whether one or more sensor patches require re-positioning is performed at the one or more bridges.

In some embodiments the method of determining whether one or more sensor patches require re-positioning is performed at the one or more sensors.

In some embodiments the information on re-positing the one or more sensors is provided by the one or more bridges.

In some embodiments the information on re-positing the one or more sensors is provided by the one or more sensors.

In step 711, if it is found that the quality of the received signal and/or the quality of the sensory data and/or the signal strength of the one or more body-coupled communication channels is above their respective pre-defined thresholds, it is determined that the one or more sensors may be correctly positioned.

In some embodiments the low bandwidth communication channel (BCC channel) may only be activated when an unpaired sensor appears in the high bandwidth communication channel (BLE) list. This may result in a power saving at the hub.

In some embodiments after activation the sensor unit may start taking sensor readings, and transmitting those readings. However, if the sensor is attached to an (incorrect) patient and paired to a bridge corresponding to another patient, those readings may be disregarded as the readings may be from another (incorrect) patient.

In some embodiments guidance to the user on how to improve signal quality may only commence after the application of the sensor to the (correct) patient. Thus, when it is determined that the application of the sensor and hub is to the same (correct) patient, via a valid connection through body-coupled communication, for example, via any of the two-channel ID loop-back methods discussed earlier, placement guidance is given to a user in order to find the optimal position on the body for optimal sensor readings.

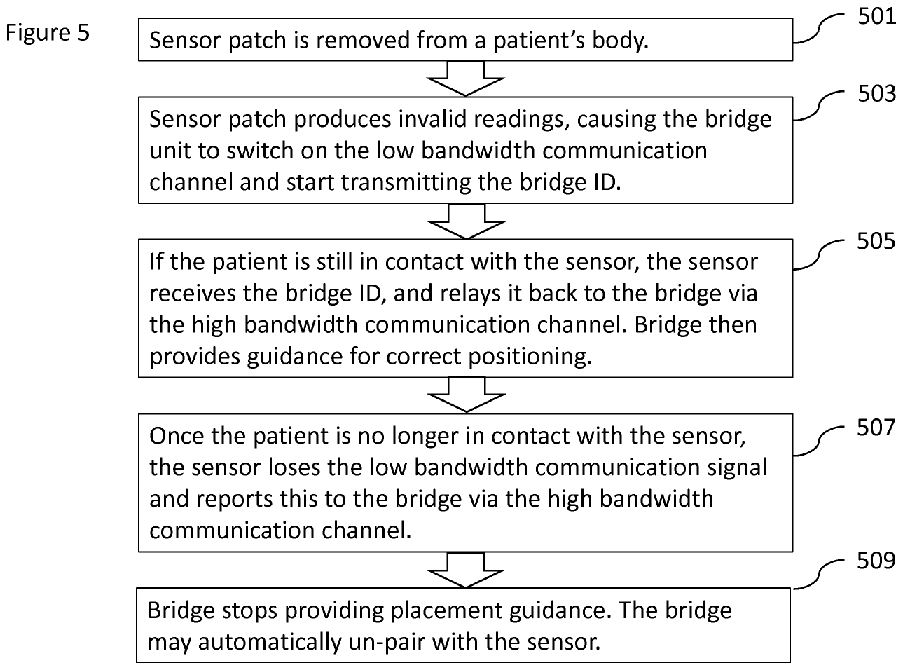

The above method has described the pairing of the bridge and the sensor patch, as well as positioning of the sensor patch. A method of un-pairing the bridge and the hub will now described with reference to FIG. 5.

FIG. 5 shows a method of the process of un-paring a sensor from a bridge device. In a scenario where a sensor unit is removed from a patient's body sensor network (BSN), the following steps may be performed. The sensor unit may be removed for any number of reasons. By way of example only the sensor may no longer be needed or the sensor has a low battery status.

In step 501, the sensor patch is removed from the patient's body 501.

In step 503, the sensor patch may then produce invalid sensor readings which are received by the bridge unit or no readings. The bridge unit will switch on the low bandwidth communication channel (BCC) and start transmitting the unique ID (bridge ID) via the low bandwidth communication channel (BCC)

In step 505, the patient is still in contact with the sensor, for example holding the sensor in their hand, the sensor may receive the low bandwidth communication channel (BCC) signal and relay it back to the bridge via a high bandwidth communication channel (BLE) transmission. As such, the bridge may think that the sensor is still attached to the patient and providing invalid signals. The bridge may then start to provide guidance for correct positioning.

In step 507, once the patient is no longer in bodily contact with the sensor, for example the patient releases the sensor, the sensor may lose the low bandwidth communication channel (BCC) signal and report this to the bridge via the high bandwidth communication channel (BLE). The bridge is able to determine that the sensor has left the patient's body.

In step 509, the bridge may then stop providing guidance for correct placement of the sensor. The bridge may also stop communicating via the low bandwidth communication channel. The bridge may also automatically un-pair the sensor, to avoid erroneous data that the sensor may still be collecting and transmitting, for example, where the same sensor is re-used on another patient, this data would not be desired by the first patient's BSN.

Some embodiments provide that the low bandwidth communication channel (BCC) of the bridge may be de-activated when a sensor has left the body, this may be due to a break in the body-coupled communication between the sensor and the bridge or it may be detected via an invalid sensor signal or separate body contact sensing technology. De-activating the low bandwidth communication channel may enable the bridge to save power.

Some embodiments may provide that no misplaced guidance on sensor placement is given to the user when the patient disposes of a sensor.

Some embodiments may provide immediate or delayed automatic un-pairing of sensors that have left the body, this may result in fewer medical errors, where the sensor data is not accurate with regard to a particular patient.

In some embodiments the bridge may conclude that the sensor has left the body when the bridge receives invalid sensor readings from the sensor, whilst transmitting its unique ID via the low bandwidth communication channel (BCC), and listening at the low bandwidth communication channel (BCC) receiver, wherein the bridge does not receive the sensor's low bandwidth communication channel (BCC) ID anymore.

As invalid sensor signals may not always be easy to detect. In some embodiments the low bandwidth communication channel (BCC) signal coupling strength may be used as an indicator of how well a sensor is attached to the body of the patient. This in turn may then be used as a trigger to assume that subsequent sensor data is invalid, and cause the bridge to provide guidance to check sensor positioning, even if the sensor itself may not indicate invalid data yet. It should be appreciated that the sensor may be able to provide sensor positioning guidance, or another device which is in communication with the bridge device.

Such embodiments may be useful for sensors that may not have galvanic skin contact, for example posture and/or motion sensors. For accurate readings such sensors may be closely aligned to the body, for example because if the sensor is able to move independent to the patient's body which it is monitoring, the sensor may not be able to track the body posture/motion accurately. The sensors which may be closely aligned to the body, may result in a specific low bandwidth communication channel (BCC) coupling strength. The specific strength may be identified during an initial calibration sequence of the sensor. The calibration sequence of the sensor may comprise:

the sensor being attached to the body;

a user of the device confirming that it is well positioned;

the sensor measuring the low bandwidth communication channel (BCC) signal coupling strength;

the signal coupling strength being stored as a reference;

the sensor detecting a decrease in the low bandwidth communication channel (BCC) signal coupling strength; and

the detection of the decrease in the low bandwidth communication channel (BCC) signal coupling strength causing a notification to be sent to the user.

It should be appreciated that this function may also be implemented using regular capacitive touch technology.

Embodiments of the present invention may have several applications, for example, body sensor networks (BSNs), wearable sensors, personal health devices, etc. It should be appreciated that embodiments described herein may have other applications, and that this list is not intended to be restrictive.

It should be appreciated that the above described arrangements may be implemented at least partially by an integrated circuit, a chip set, one or more dies packaged together or in different packages, discrete circuitry or any combination of these options.

Various embodiments with different variations have been described here above. It should be noted that those skilled in the art may combine various elements of these various embodiments and variations.

Such alterations, modifications, and improvements are intended to be part of this disclosure, and are intended to be within the scope of the present invention. Accordingly, the foregoing description is by way of example only and is not intended to be limiting. The present invention is limited only as defined in the following claims and the equivalents thereto.

1. A communication method comprising:
receiving at a first communication device, a signal from a second communication device over a first communication channel, wherein the signal comprises first information;
transmitting a response from the first communication device to the second communication device over a second communication channel, wherein the response is dependent on the signal, and
initiating pairing between the first communication device and the second communication device by the second communication device, pairing if the said response matches a criterion,
wherein the first communication channel is a body coupled communication channel and the second communication channels is a radio frequency channel.

2. A communication method comprising:
transmitting at a second communication device, a signal over a first communication channel to a first communication device, wherein the signal comprises first information;
receiving a response from the first communication device over a second communication channel, wherein the response is dependent on the signal, and
initiating pairing by the second communication device, if the response matches a criterion, wherein the pairing is between the first communication device and the second communication device,
wherein one of the first communication channel and the second communication channel is a body coupled communication channel and the other of the first communication channel and the second communication channel is a radio frequency channel.

3. The method as claimed in claim 1, wherein a quality of information received by one of the first communication device and the second communication device from the other of the first communication device and the second communication device is used to determine a relative location of the one device relative to the other.

4. The method as claimed in claim 1, wherein a signal quality of the body coupled communication channel received by one of the first communication device and the second communication device from the other of the first communication device and the second communication device is used to determine a relative location of the one device relative to the other.

5. The method as claimed in claim 3, further comprising determining from the determined relative location if one of the first communication device and the second communication device is to be moved from a current location and if so providing output information indicating that the one of the devices is to be moved.

6. The method as claimed in claim 1, wherein a quality of information received by one of first communication device and the second communication device from the other of the first communication device and the second communication device is used to determine if the first communication device and the second communication device are no longer communicating via one of the channels.

7. The method of claim 6, wherein the one of the first communication channel and the second communication channel is a body coupled communication channel.

8. The method of claim 1 any preceding claim, wherein one of the first communication channel and the second communication channel is a relatively high bandwidth communication channel and the other of the first communication channel and the second communication channel is a relatively low bandwidth communication channel.

9. The method of claim 1, wherein one of the first communication device and the second communication device is a sensor device and the other of the first communication device and the second communication device is a bridge device.

10. The method of claim 1, further comprising pairing the first communication device and the second communication device.

11. The method of claim 1, further comprising one of the first communication device and the second communication device receiving monitor information and the other of the first communication device and the second communication device transmitting monitor information.

12. The method as claimed in claim 1, further, comprising determining if a subsequent signal is one of received or transmitted within a respective time, and if not causing at least one of the first communication device and the second communication device to be in a lower power mode.

13. The method of claim 1, wherein when the signal is not received by one of the first communication device and the second communication device via at least one body coupled communication channel from the other of the first communication device and the second communication device then the first communication device and the second communication device un-pair after a specified duration.

14. A first communication device comprising:
a receiver,
wherein the receiver is arranged to receive a signal from a second communication device over a first communication channel,
wherein the signal comprises first information; and
a transmitter,
wherein the transmitter is arranged to transmit a response to the second communication device over a second communication channel,
wherein the response is dependent on the signal,
wherein the response is configured to cause the second communication device to initiate a pairing between the first communication device and the second communication device on the second communication channel by matching a criterion,
wherein the first communication channel is a body coupled communication channel and the second communication channel is a radio frequency channel.

15. A second communication device comprising:
a transmitter,
wherein the transmitter is arranged to transmit a signal over a first communication channel to a first communication device,
wherein the signal comprises first information; and
a receiver,
wherein the receiver is arranged to receive a response from the first communication device over a second communication channel,
wherein the response is dependent on the signal,
wherein the second device is configured to initiate pairing on the second communication channel, between the first communication device and the second communication device if the response matches a criterion
wherein the first communication channel is a body coupled communication channel and the second communication channel is a radio frequency channel.

16. The method as claimed in claim 4, further comprising determining from the determined relative location if one of the first communication device and the second communication device is to be moved from a current location and if so providing output information indicating that the one of the devices is to be moved.
